(19) United States
(12) Patent Application Publication
(10) Pub. No.: US 2022/0131124 A1
(43) Pub. Date: Apr. 28, 2022

(54) METHOD FOR MANUFACTURING ALL-SOLID-STATE BATTERY

(71) Applicant: MTEK-SMART CORPORATION, Yokohama-Shi, Kanagawa (JP)

(72) Inventor: Masafumi MATSUNAGA, Yokohama-Shi (JP)

(73) Assignee: MTEK-SMART CORPORATION, Yokohama-Shi, Kanagawa (JP)

(21) Appl. No.: 17/429,150

(22) PCT Filed: Jan. 29, 2020
(86) PCT No.: PCT/JP2020/003177

§ 371 Date: Aug. 6, 2021

(30) Foreign Application Priority Data
Feb. 8, 2019 (JP) 2019-021969

(51) Int. Cl. H01M 4/04; H01M 4/133; H01M 4/134; H01M 10/0562

(52) U.S. Cl. CPC H01M 4/0419; H01M 4/133; H01M 2004/028; H01M 10/0562; H01M 4/134

(57) ABSTRACT

Electrodes are formed by, as a dry method, alternately applying electrode active material and electrolyte particles as thin-film layers. Furthermore, the films are formed wholly or partially by employing an aerosol deposition method. Moreover, high-density layers can be formed and adhesion is improved by, as a wet method, impactfully and alternately colliding, with a target object, slurry made primarily from an electrode active material and solvent and a slurry made primarily from electrolyte particles and a solvent, adhering same in thin films and layering same. A slurry made primarily from a conductivity aid and a solvent is independently prepared, and a small quantity thereof is applied diffusely at a desired position. Moreover, by using no binder or keeping binder content low, residual carbon can be eliminated or kept low so as to improve battery performance.

### TECHNICAL FIELD

The present invention relates to a method for manufacturing an all-solid-state battery being a laminated structure including a positive electrode layer, an electrolyte layer, and a negative electrode layer, which includes: preparing powder or the like containing particles such as active materials and electrolyte or a slurry containing the powder; forming both of the electrode layers; and forming the electrolyte layer from the electrolyte particles. Although the following description of embodiments refers mainly to the method for manufacturing the all-solid-state battery, this method is suitable for storage batteries in general and can be applied to all solid-state batteries which are considered to be a promising next-generation battery. In detail, the method for manufacturing the all-solid-state battery includes: selecting at least one desire material selected from the group consisting of positive electrode active material particles, electrolyte particles or short fibers, negative electrode active material particles or short fibers, conductive assistant particles or short fibers, and binder; and applying the at least one material on an object, in which the object is at least one selected from the group consisting of a positive electrode current collector, a positive electrode layer, an electrolyte layer, a negative electrode layer, and a negative electrode current collector. The material as particles or fibers may be applied or deposited to the object, or it may be applied as a slurry.

The application according to the present invention is not limited to any particular method, but includes the application of particles or fibers to an object, such as electrostatic atomization (including fiberization), powder electrostatic coating, atomization (including fiberization) including spraying, inkjet, dispensing, curtain coating, screen printing, slit die (slot nozzle) coating, and roll coating, which also include microcurtain application.

The microcurtain is a method for applying a part of liquid film before it becomes a mist, at a relatively low pressure of around 0.3 MPa using a spray nozzle such as an airless spray nozzle with a wide angle pattern, in which the spray nozzle moves relative to an object to be applied, whereby no overspray particles are generated on the applied surface. This method utilizes the characteristics in which it changes to the mist as the distance from the object increases when it passes through the object to be applied. In addition to particulation by spraying, the atomization (fiberization) includes applications of liquid containing solid fine particles by dispersing the liquid with ultrasonic waves, or particulizing or fiberizing the liquid by spinning such as electrospinning or centrifugal force of a rotating body. In addition, there are spraying, other methods such as bubbling and ultrasonics, a method where the fine particles generated by colliding with other objects are carried by carrier gas and then stretched at high speed with or without another compressed gas to form a jet for application in a very fine pattern and a method where particles and fibers compatible with wide objects with high line speed are produced by the application of the meltblown method to liquids. Since directionality of the atomized particles is unstable in the above-mentioned ultrasonic and centrifugal atomization, the methods are related to a method for attaching or applying it to the object with a compressed air assist. In the present invention, these are collectively described below as a splay.

### BACKGROUND ART

As mobiles and electric vehicles increase, there is a need for quick charging of secondary batteries including lithium batteries, but tens of minutes are required for charging in electric vehicles. Because of the length of time, safety risks and the like, development to change electrolyte from liquid to solid is underway to reduce 80% charging time to a few minutes.

Patent Document 1 proposes a method for manufacturing an all-solid-state battery being a layered structure including a solid electrolyte layer, a positive electrode active material layer, and a negative electrode active material layer, and introduces a technology for forming electrodes, including: preparing a slurry containing materials for constituting the layered structure; forming a green sheet; forming integrally the green sheet and a sheet having asperities that disappears when heated; forming the asperities on the surface of the green sheet; heating the integrally formed green sheet and the sheet to disappear the sheet material, and firing the green sheet to form asperities on base material.

Patent Document 2 proposes a polyvinyl acetal resin for an electrode slurry containing active material particles, solvent and binder and for an electrolyte slurry containing electrolyte particles, solvent and binder, to form electrode layers and electrolyte layers for an all-solid-state battery and for laminating them, which can be debindered in a short time at low temperature. More specifically, a solid electrolyte slurry and a negative or positive electrode slurry are applied on a support layer of mold-release treated PET film, the PET film is peeled off after drying at 80° C. for 30 minutes, the electrolyte layer is sandwiched between the negative and positive electrode active material layers and then heated and pressurized at 80° C. and 10 kN to obtain a laminated structure, and conductive paste containing acrylic resin is applied on a stainless steel plate to make a current collector, and it is fired at 400° C. or lower under a nitrogen gas atmosphere to debinder the binder.

In the method disclosed in Patent Document 1, the active material slurry and electrolyte slurry are applied to a sheet of polyvinyl alcohol or the like with asperities, which is ideal because of the increased contact area of the active material and electrolyte layers, but the resin content needs to be disappeared at high temperatures for a long time, for example, 50 hours at 700° C. Patent Document 2 has a problem that volatilizing the solvent in the slurry takes 30 minutes at 80° C., so manufacturing lines for lithium-ion batteries would have to be much longer in order to maintain the current line speed of 100 m/min, or the line speed would have to be reduced. In both methods, when the binder in the slurry is eliminated or reduced, particle precipitation occurs at points where the slurry tended to stagnate in the general circulation system, and the application could not be performed with a die head used for electrode formation in lithium batteries. In addition, each electrode needs to be formed by uniformly mixing the active material particles and electrolyte particles or conductive assistants in the desired proportions, but when the binder content is less than 10 percent or even less than 5 percent, only electrodes with unstable performance can be formed due to changes over time, even when uniformly dispersed and mixed using commercially available dispersion equipment.

### RELATED ART DOCUMENTS

### Patent Documents

Patent document 1: WO2012/053359A
Patent document 2: JP2014-212022A

### SUMMARY OF THE INVENTION

### Problems to be Solved by the Invention

The purpose of the present invention is to improves productivity, to eliminate or minimize residual carbon generated during firing in a laminated structure that requires the firing, to improve adhesiveness of interface between the layers, and to widen the surface area of the interface between the electrode layer and electrolyte layer to lower the interfacial resistance and improve the battery performance. The electrode layer is a mixture of the active material for the electrode and the electrolyte particles, fibers, or conductive assistant. If more binder is used to improve the stability of the slurry, the dispersion state of the active material, electrolyte, and conductive assistant changes over time, resulting in performance degradation, and this problem needed to be solved. In the present invention, various types of sulfides and oxides can be used for solid electrolyte particles. Various types of positive and negative electrode active material particles can also be used. For example, if the electrolyte is a sulfide such as lithium phosphorus sulfide (LPS), the positive electrode active material can be lithium sulfide (Li2S) particles or a mixture of sulfur, especially octasulfur (S8) particles, and the conductive assistant, and the negative electrode active material can be graphite and silicon particles. The negative electrode can be a metallic lithium plate or a lithium alloy plate. If the electrolyte is lithium lanthanum zirconia (LLZ), the negative electrode active material can be octasulfur, and a mixture of octasulfur and the conductive assistant such as nanofibers of nanocarbon, carbon nanotubes, or a mixture of graphene and porous carbon in order to improve the conductivity thereof. If the positive electrode active material is lithium sulfide, a mixture of lithium iodide can be used as a lithium conductive assistant. The lithium iodide can be made into a solution with a parent solvent or into a slurry with a poor solvent or the like.

### Means of Solving the Problems

The purpose of the present invention is to solve the aforementioned problems, which includes applying or depositing positive electrode active material particles and electrolyte particles or short fibers and optionally conductive assistants on a positive electrode current collector and electrolyte layer to make multiple thin layers by using independent device. In the same way, negative electrode active material particles or fibers and electrolyte particles can be applied or deposited on an electrode current collector or electrolyte layer to make the multiple thin layers.

In this invention, the method disclosed in WO2013108669 invented by the inventor is used to measure coating weight per unit area accurately by applying the coating to the object to be measured before applying the coating to the object or substrate. Therefore, the coating weight of each material can be controlled for the smallest part of the electrode, and ultra-high quality electrodes can be formed.

The present invention provides a method for manufacturing an all-solid-state battery having a positive electrode, an electrolyte, and a negative electrode in layers, including:

selecting at least two materials selected from the group consisting of positive electrode active material particles, electrolyte particles or short fibers, negative electrode active material particles or short fibers, conductive assistant particles or short fibers, and a binder; and

by using each coating device for the respective materials, applying the materials alternately on an object so as to form multiple thin layers,

wherein the object is at least one selected from the group consisting of a positive electrode current collector, a positive electrode layer, an electrolyte layer, a negative electrode layer, and a negative electrode current collector.

The present invention provides the method, in which the number of the layers made of the particles or the fibers is 2 to 30.

The present invention provides the method, in which the at least two materials are positive electrode active material particles and electrolyte particles or short fibers.

The present invention provides the method, in which

the at least two materials are at least three materials,

the conductive assistant is selected from at least one of carbon nanofibers, porous carbon particles, carbon nanotubes, and graphene,

the conductive assistant and the active material are alternately applied, and

the conductive assistant is at least scattered thereby the conductive assistant do not form a continuous layer.

The present invention provides the method, in which the electrolyte is sulfide, and

the positive electrode active material is porous carbon particles or carbon short fibers and metallic silicon or silicon oxide (SiOx).

The present invention provides the method, in which the object is an oxide electrolyte, and

the positive active material and the conductive assistant are alternately applied.

The present invention provides the method, in which a base of the oxide electrolyte is lithium lanthanum zirconia,

the positive electrode active material is sulfur particles, and

the conductive assistant is at least one selected from the group consisting of carbon nanofibers, mesoporous carbon particles, carbon nanotubes, and graphene.

The present invention provides the method, in which at least two slurries including a solvent and at least one selected from the positive electrode active material particles, electrolyte particles or short fibers, negative electrode active material particles or short fibers, conductive assistant particles or short fibers, and binder are alternately applied on the object to form the multiple thin layers.

The present invention provides the method, in which each slurry is applied to the object in the form of particles in order to form fine irregularities at least at an interface between the positive electrode layer and the electrolyte layer, or at an interface between the electrolyte layer and the negative electrode layer of the positive electrode active material particles, electrolyte particles or short fibers, negative electrode active material particles or short fibers, conductive assistant particles or short fibers, and binder to increase a surface area of each interface.

The present invention provides the method, in which the slurry is applied as particles with a pulsed dosing device or a pulsed splay coating device head,

pulses are applied at 1 to 1000 Hz, and

a distance between the head and the object is 1 to 60 mm.

The invention provides the method, in which the fine irregularities promote volatilization of the solvent of the slurry particles by heating the object, and

the fine irregularities include a combination of irregularities of trajectory caused by lapping of pulsed spray pattern and fine irregularities caused by the spray particles.

The present invention provides the method, further including filling or applying alternately the at least two materials selected from the group consisting of positive electrode active material particles, electrolyte particles or short fibers, negative electrode active material particles or short fibers, conductive assistant particles or short fibers, and binder on at least one substrate in advance so as to form the multiple thin layers, and transporting the filled or applied materials with a pressure difference to the upstream of the object under vacuum to apply and deposit the materials onto the object by splaying.

The present invention provides the method, in which the filling or applying of the at least two materials onto the at least one substrate in the form of the multiple thin layers is filling or applying onto separate substrates, and

the materials on the separate substrates are transported to the upstream of the object with a pressure difference under vacuum to apply and deposit the material alternately onto the object by splaying.

The present invention provides the method, in which the filling or applying of the at least two materials onto the at least one substrate in the form of the multiple thin layers is to apply the at least two slurries including a solvent and at least one selected from the positive electrode active material particles, electrolyte particles or short fibers, negative electrode active material particles or short fibers, conductive assistant particles or short fibers, and binder.

In the present invention, various types of sulfides and oxides can be used for solid electrolyte particles. Various types of positive and negative electrode active material particles can also be used.

For example, if the electrolyte is a sulfide, such as lithium phosphorus sulfur (LPS), the positive electrode active material can be lithium sulfide (Li2S) particles or a mixture of sulfur, octasulfur (S8) particles and a conductive assistant, and the negative electrode active material can be graphite and silicon particles. The negative electrode can be a metallic lithium plate or a lithium alloy plate. If the electrolyte is an oxide material such as lithium lanthanum zirconia (LLZ), the positive electrode active material can be the sulfur or a mixture of the sulfur and conductive assistant such as nanocarbon or porous carbon to improve conductivity. The negative electrode can be a lithium plate or a lithium alloy plate. If the positive electrode active material is lithium sulfide, a lithium conductive assistant can be a mixture of lithium iodide. The lithium iodide can be made into a solution with a parent solvent or into a slurry with a poor solvent.

In the present invention, the material includes two or more material and at least two of the material can be selected and applied or dispersed multiple times to make multiple layers. For example, the conductive assistant may be graphene and carbon particles, graphite particles and carbon nanofibers, or carbon nanotubes, especially single-walled carbon nanotubes that are effective with small additions.

In this invention, the methods disclosed in WO2014/171535 and WO2016/959732 invented by the inventor can be used or applied.

In other words, in order to improve the performance of all-solid-state batteries, the application or filing to the substrate is performed so as to achieve a stable weight per unit area before applying or depositing the active material particles, meso and other porous carbon particles, carbon nanotubes, carbon nanofibers, graphene and other conductive assistants, as well as electrolyte particles and short fibers on the substrate in advance. For example, the selected positive electrode active material particles and electrolyte particles, and optionally a conductive assistant can be applied or filled alternately on a single substrate to make multiple thin layers and sprayed or deposited using differential pressure, for example, to the object under vacuum. The method disclosed in WO2016/959732 is convenient for the applying, and the method disclosed in WO2014/171535, which can be applied to objects under high vacuum, is convenient for deposition. A plurality of substrates can be prepared for each material, and the positive or negative electrode active material can be applied or filled on one of the substrates, and a binder in form of powder, such as PTFE and PVDF can be applied or filled on the remaining substrates, and the active material and binder can be applied or filled on the object alternately to make the multiple layers. The binder can be attached or encapsulated in very small amounts to the active material and electrolyte particles in advance. The binder can be a vinyl or other resin dissolved in a solvent or an emulsion.

In the present invention, it can also be applied as a slurry. Regardless of whether the electrolyte is sulfide or oxide, the amount of binder in each slurry, the amount of the binder in each slurry is preferably 10% or less of the total solid content by weight, especially when firing is performed in a subsequent process, and preferably 2% or less for reasons such as minimizing residual carbon. When the binder included, it is possible to create an electric potential difference between the target object and slurry or fine particles made by spraying, and to support the adhesion of the fine particles electrostatically. The application of static electricity is particularly effective for the adhesion of ultra-fine particles having sub-micron size or smaller. In order to electrostatically charge the sprayed particles, the binder or solvent as described above should be selected to be easily charged by the static electricity

According to the method for manufacturing the all-solid-state battery of the present invention, splayed particles, for example, can be attached to the object with impact, with a splay angle of 30 degrees or less, preferably 15 degrees or less, and with a distance to the object being 60 millimeters or less, more preferably 30 millimeters or less, resulting in forming ultra-dense particle groups. In addition, the electrode interface can be easily formed with fine irregularities by impact splaying and, if necessary, with desired size irregularities by pulsed splay pattern trajectory, so that the contact area with the electrolyte layer can be increased, adhesion can be enhanced by the anchor effect, and interfacial resistance can be maximized. The effective irregularities of the splay pattern can be applied to distribution of high flow rates at both ends of the micro-curtain coating described above.

The positive electrode layer, electrolyte layer, and negative electrode layer can all be made into particles by spraying slurries for the electrodes or slurries for the electrolytes to form a laminated body. On the other hand, the electrode active material particles and the electrolyte particles or short fibers, and optionally a binder and/or a conductive assistant for mainly the positive electrode, are independently mixed with a solvent to make a slurry, and the positive and negative electrode layers can be made in a thin layer by die-coating, roll-coating, curtain-coating, screen-coating, or the like, resulting that the processing speed can be increased.

The active material is applied in the form of thin stripes, preferably within a width of 1 mm, and even more preferably within a width of 0.5 mm, and with a dry film thickness of 10 micrometers or less, and even more preferably 5 micrometers or less. The electrolyte is applied with a similar width between the stripes using a different coating device. The electrodes including dense electrolyte particles and electrode particles can be formed at high speed by preparing the multiple layers in the same manner while shifting the phase of the stripe pitch. Furthermore, a laminated body can be formed by attaching particles derived from a slurry including a mixture of electrolyte and active material, and optionally a conductive assistant, on the interface of the positive layer, electrolyte layer, negative electrode layer, or electrode current collector, with impact using a spray method.

Furthermore, in the present invention, a single slurry mixed with multiple types of particles can be applied to make the multiple layers, but this is not limited thereto. Different types of slurries can be made and a plurality of heads corresponding to them can be used. For example, when the electrode particles and the electrolyte particles with different specific weights and particle diameters are mixed together to make a slurry without binder or with a small amount of binder, no matter how uniformly they are mixed, they will settle over time or instantly, and the dispersion state will change. An ideal laminated body of the electrode can be obtained by separately preparing a slurry including mainly the electrode active material particles and the solvent, and a slurry including mainly the electrolyte particles or fibers and the solvent, setting the spraying amount at the desired ratio for each, and applying each constantly, e.g., alternately, in a thin layer in the desired overlap.

In addition, this method is effective for making the multiple layers having the desired distribution of conductive assistants such as carbon particles and carbon nanofibers and active materials with different specific gravity and particle size, which differ greatly in their ratio per volume. Too little or too much of the conductive assistant per unit volume of the electrode layer will affect the performance, so it is far better than the application of a mixed slurry with the active material. In addition, binders of inorganic or organic particles or fibers, such as PTFE and PVDF in form of resin-based powders or short fibers, or binders of electrolytic glass-based short fibers, and solvents, and optionally resin-based solutions, emulsions or the like can be added to make a slurry that is independent and can be applied to desired areas in desired quantities.

In particular, if a slurry with a lower solid concentration (e.g., 10% or less) derived from the conductive assistant is applied in a thin layer over and over so as to get entangled on the electrolyte particles or the active material particles to make multiple layers, the amount of the application per unit area becomes more uniform, leading to improved battery performance.

Furthermore, in the present invention, a strong adhesive can be partially applied to silicon particles to prevent performance degradation due to expansion and contraction of silicon and silicon oxide particles, which are effective for the negative electrode. In other words, a slurry containing the silicon particles and a solution or emulsion of the strong adhesive or resin particles or fibers can be made into particles by separate heads and applied to form an electrode layer by partially attaching them to the silicon surface as adhesive particles. In particular, a pulsed method with impact is the best way to splay the adhesive or change it into fine particles to transfer and partially adhere to the silicon surface. It is also possible to add carbon particles of the negative electrode active material to the adhesive solution or emulsion of the adhesive to make a slurry for the application. In addition, tens or hundreds of nanometers of metallic silicon or silicon oxide can be loaded into the porous carbon pores to prevent silicon from dropping out due to expansion and contraction during charging and discharging of the all-solid-state battery.

The object can also be heated. The heating temperature is preferably between 30 and 150° C. By heating the object, the solvent content in the particulated slurry can be evaporated at the same time as it contacts with and wets the object. The time required to evaporate 95% of the solvent is preferably within 5 seconds, ideally within 2 second. When the time is longer than 2 seconds, the group of high-density particles deposited by the impact tends to be loosened by the solvent. Also, if all the solvent evaporates instantly upon impact, the solvent vapor can easily scatter the spray particles and cause the binder to boil.

In the present invention, when the slurry is converted into particles and adhered to the object in a pulsed manner, the impact can increase. In particular, in the air spray method, which is known in the industry as a two-fluid spray, the mass of the air surrounding the sprayed particles is 400 to 600 times greater than usual, so particles arriving later on the object are pushed back by the rebounding air on the object, resulting in loss of impact and extremely poor particle adhesion efficiency. On the other hand, in the impact pulse method in which both slurry and air are applied in a pulsed manner, compressed air between a spray particle cluster and another spray particle cluster diffuses, and only the directional particles move and adhere. As a result, it is also economical because of an adhesion efficiency of more than 95%, compared to about 30 to 50% for ordinary sprays. By using the pulsed spraying, for example, the amount of the conductive assistant to be applied can be reduced to less than one-tenth of that of normal spraying when adjusting the ratio of the active material, which is extremely convenient.

### Effects of the Invention

As described above, the present invention can be used to produce an all-solid-state battery with high performance.

### BRIEF DESCRIPTION OF DRAWINGS

FIG. 1 shows a schematic diagram of spraying active material onto an object (current collector) and then dispersing and coating the active material particles so that the conductive assistant adheres to them, according to the present embodiment.

FIG. 2 shows a schematic diagram for electrolyte particles and different (e.g., conductive assistant) particles being splayed onto the active material particles attached on the object, according to the present embodiment.

FIG. 3 shows a schematic cross-sectional view of two types of particles laminated together, according to the present embodiment.

FIG. 4 shows a schematic cross-sectional view of a current collector, positive electrode layer, electrolyte layer, negative electrode layer, and current collector laminated together, according to the present embodiment.

FIG. 5 shows a schematic cross-sectional view of electrode slurries being splayed onto the objects (current collector and electrolyte layer), according to the present embodiment.

FIG. 6 shows a schematic cross-sectional view of the splay on the objects (electrolyte layer and electrode layer), according to the present embodiment.

FIG. 7 shows a schematic cross-sectional view of the splay on the object (electrolyte layer), according to the present embodiment.

FIG. 8 shows a schematic cross-sectional view of the lamination by the alternated splaying of different materials onto the object (current collector) in a pulsed manner and with a time difference, according to the present embodiment.

FIG. 9 shows a schematic cross-sectional view of a plurality of materials stacked on a substrate using a plurality of coating devices in advance of applying or depositing the materials on the object.

### DESCRIPTION OF EMBODIMENTS

Now, a preferred embodiment of the present invention will be described with reference to the drawings. However, the embodiment below is only an example for facilitating the understanding of the present invention. Addition, replacement, deformation, or the like executable by those skilled in the art can be made thereto without departing from the technical idea of the present invention.

The drawings schematically show the preferred embodiment of the present invention.

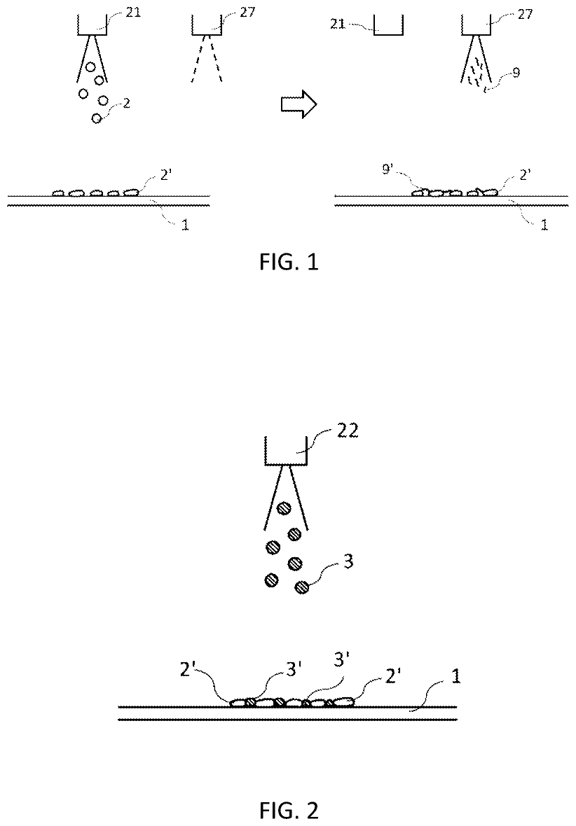

In FIG. 1, a slurry containing electrode active material particles and a solvent or a slurry containing active material particles, a solvent and a binder is sprayed from a spray head 21 onto a current collector 1 as an object, resulting that active material spray particles 2 are attached thereon. A conductive assistant 9 or 9′ can be applied to the active material from another spray head 27 and dispersed on the active material 2′. The object can be a sheet or a long sheet. The coating device can be either batch type or roll-to-roll type. Any type of the active material particles can be used. When an electrolyte is made of sulfide, a positive electrode active material such as lithium cobalt oxide (LCO), lithium nickel manganese cobalt oxide (NMC), lithium nickel cobalt aluminum oxide (NCA) or the like reacts with sulfur, resulting that it is difficult for lithium ions to pass through. Therefore, the active material particles may be coated with a thin layer of lithium niobate or other materials. The active material particles or electrolyte particles may be encapsulated with the electrolyte or the active material, respectively, which makes the process shorter and simpler, and thus more productive. Adhesion can be improved by pulsed spraying and attaching the spray particles to the current collector with impact at a high speed. The impact on the sprayed particles 2 can be archived by keeping the distance between the object and the spray head close, e.g., 1 to 60 mm, and by pulsed splaying at a gas pressure of 0.15 to 0.3 MPa using a two-fluid nozzle with a splay pattern of a narrow splay angle, e.g., at 30 degrees or less, preferably 20 degrees or less. The number of pulses per second is preferably 10 Hz or higher for productivity. The shorter the distance and the narrower the splay pattern angle, the higher the impact. A slurry containing mainly the electrolyte particles and solvent may be sprayed first. It is preferable that a room where the spray is applied such as a booth, is under exhausted conditions. If the electrolyte is sulfide, the supplied gas should be dehumidified. The lower a dew point temperature, the better the dehumidification. For example, an all-solid-state battery with almost no hydrogen sulfide and good performance can be produced at a temperature of minus 80 degrees Celsius or less. For materials that need to avoid oxidation, a heating process, for example, may be performed under an inert gas (e.g., argon) atmosphere to suppress oxidation reaction if necessary.

FIG. 2 shows dispersed applying of particles 3 and 3′ in a thin layer by splaying a slurry (containing, e.g., electrolyte particles) different from that of FIG. 1 around and on top of the thin layer such as a single layer (e.g., made of an active material 2) with a head 22. The splay of the active material from the head 21 in FIG. 1 and the splay of the electrolyte from the head 22 may be applied alternately to build up multiple thin layers. Instead of or in addition to the electrolyte particles, a solution or slurry including a conductive assistant such as lithium iodide or at least one conductive assistant selected from the group consisting of carbon particles, carbon fibers and carbon nanotubes, or a slurry of the mixture of them with the electrode active material or the electrolyte particles is sprayed from the spray head 22 and then the sprayed particles 3 are adhered. Pore carbon and nanocarbon with large surface area, which is the conductive assistant, are excellent. For example, when it has 2,000 square meters per gram or more in BET plot, and preferably 3,500 square meters or more, the electrode performance can be improved by encapsulating the sulfur or the active materials in the positive electrode and nano-level silicon in the negative electrode, in the nano-level pores in advance.

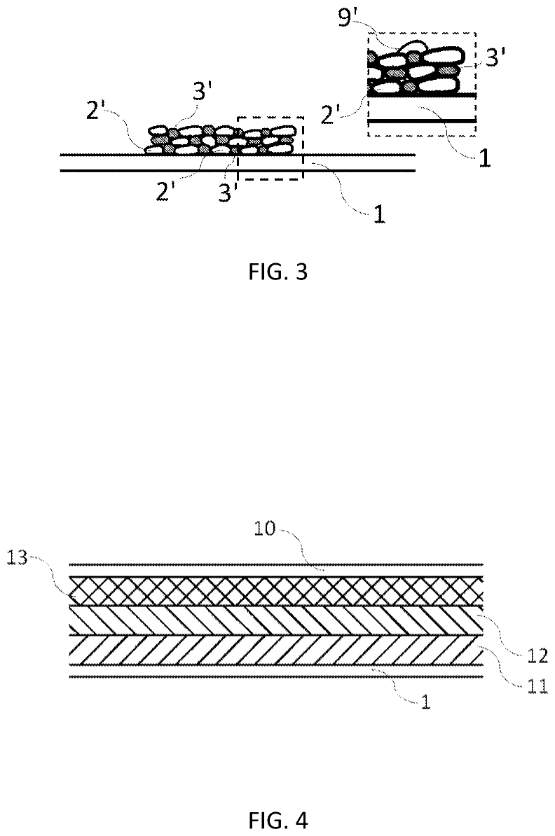

In FIG. 3, the electrode active materials 2 and electrolyte particles 3 are applied alternately to make multiple layers. Weight ratio per unit area of each can be freely selected, and the ratio can be easily adjusted by selecting the number of pulses, especially by performing pulsed spraying. Furthermore, a different spray head can be used to disperse and apply the desired amount of conductive assistant around the electrolyte and electrode active material to achieve the adhesion.

In FIG. 4, a positive electrode layer 11 and a negative electrode layer 13 are applied on both sides of an electrolyte layer 12, and the electrodes 11 and 13 are sandwiched between the current collectors 1 and 10. A laminated structure for the all-solid-state battery is completed by pressing it under heated condition or at room temperature. As the current collector, aluminum foil and copper foil are generally used for the positive electrode and the negative electrode, respectively, but not limited thereto, stainless steel sheet may be used depending on the types of the active material and electrolyte.

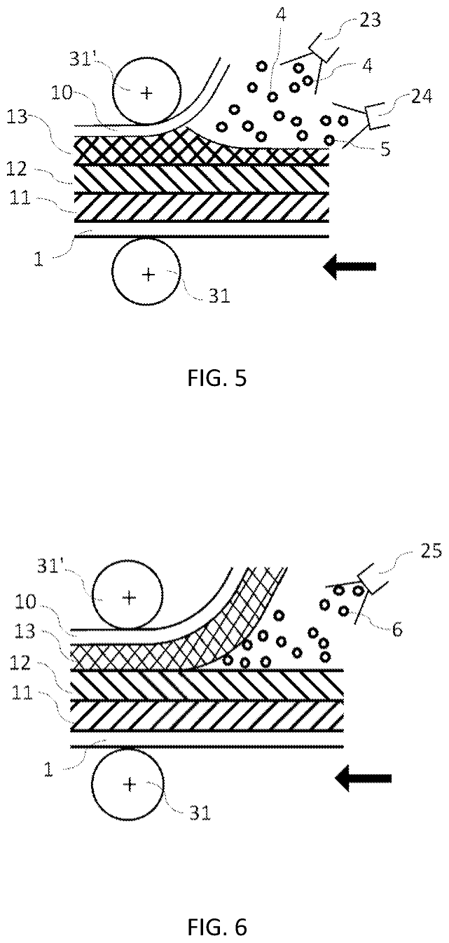

In FIG. 5, an electrolyte slurry and a negative electrode active material slurry are alternately sprayed from the spray heads 24 and 23, respectively, to form the negative electrode layer on the positive electrode current collector 1, the positive electrode layer 11, the electrolyte layer 12 and on the negative electrode current collector, and then pressing is performed using rolls 31 and 31′. When this pressing is performed in the subsequent process, the pressing pressure can be almost none or low. The rolls may be heated, and the current collector, electrode layer, and electrolyte layer may also be heated in advance to promote the volatilization of the solvent contained in the sprayed particles 4 and 5.

In FIG. 6, the electrolyte slurry, an electrode active material slurry or both is sprayed to the interface between the electrolyte layer 12 and the negative electrode layer 13 with a spray head 25. A slurry containing the electrolyte particles and electrode active material may also be sprayed. It is also possible to increase adhesive strength of the interface by spraying the solvent or the like to instantly swell the binder or the like at the respective interface. It is moved by the rolls 31 and 31′ with or without the pressing pressure. There is no limit to the load, diameter, or number of press rolls.

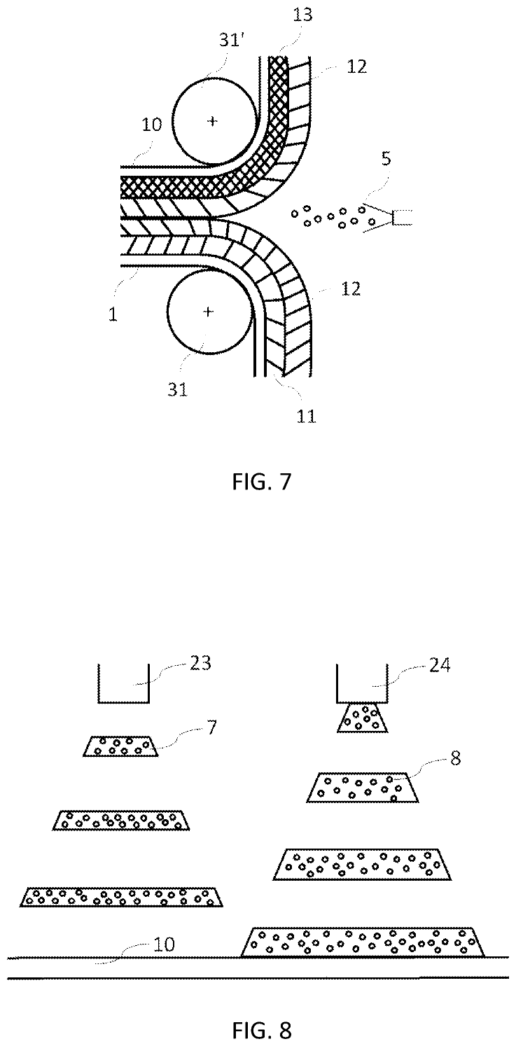

In FIG. 7, the slurry for the electrolyte layer or the solvent is sprayed onto the electrolyte layers formed on both the positive and negative electrode layers on flexible current collectors. The effect is as described above. A separately manufactured electrolyte thin plate or a flexible electrolyte membrane with which a porous substrate is filled can be sandwiched between the positive and negative electrodes without the electrolyte layer.

In this case, the electrolyte slurry, each active material slurry, binder solution, or solvent can be applied to the surface of the electrolyte or each electrode to improve the adhesion.

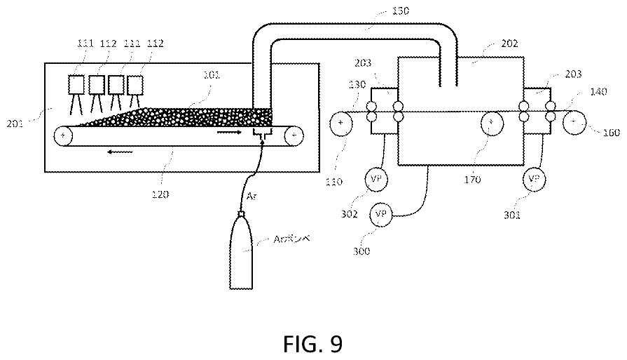

In FIG. 8, the negative electrode active material slurry is sprayed onto the negative electrode current collector 10 from the spray head 23 in a pulsed manner to form sprayed particle clusters 7. On the other hand, the electrolyte slurry is pulsed sprayed from the spray head 24 to form sprayed particle clusters 8, and each sprayed particle cluster is alternately applied on the negative electrode current collector. Preferably, it is multiple thin layers.

Similarly, a slurry containing mainly the positive electrode active material and solvent and a slurry containing mainly the electrolyte and solvent can be alternately applied on the positive electrode current collector. Furthermore, an additional head, not shown in the figure, can be used to splay a small amount of conductive assistant slurry in a pulsed manner alternately from the head 23 or 24.

If the electrolyte is a sulfide, these operations should be performed in a dehumidified environment, e.g., sufficiently dehumidified at a dew point −40° C. or less, where hydrogen sulfide is not generated.

The object may be a long R to R current collector or porous sheet for the electrolyte layer, or it may be a single leaf current collector, a porous sheet for the electrolyte or a sheet with electrodes formed on the current collector. The electrode may have a periphery formed by intermittent coating with a slot nozzle to weld tabs or other components at the end of the current collector by a laser beam. Masks can also be used in spraying, or the perimeter can be formed by the application at close range.

In FIG. 9, two kinds of materials are alternately applied to a moving substrate (belt) 120 by coating devices 111 and 112 to make multiple layers. The more times the materials are stacked, the better the result is. The two materials may be the electrode active material and the electrolyte, or they may be other materials. Three or four kinds of materials can be stacked. The belt can be porous to suck gas during suction and produce an ideal gas-powder mixture. A connecting means 150 such as a pipe is connected between the stacked material 101 and the object 130 in the vacuum chamber 202, and the differential pressure between the coating chamber 201 and the vacuum chamber causes the suction of stacked material in the entrance of the pipe to splay the material at the exit thereof, and material collides with the object to form a film on the object, and then a composite 150 of the film is wound up by the winding device 160. The composite 140 may be a dense coating layer instead of the film. The composite 140 may be pressed in a press (not shown). The vacuum chamber should be at a vacuum pressure suitable for aerosol deposition. For better film deposition, the active material should be relatively soft. Powder binder particles are easier to deposit. A pre-vacuum chamber 203 can be installed before and after the vacuum chamber to maintain the vacuum pressure of the vacuum chamber 202 at the desired vacuum pressure. The vacuum can be sucked by vacuum pumps 300, 301 and 302 to achieve the desired vacuum value. The coating chamber can also be vacuumed and an inert gas such as argon gas can be introduced from outside on the opposite side of the porous belt 120 where a laminated body of the material is sucked if the laminated material is an oxygen averse material.

In this invention, slot nozzles can be used to apply the slurry at high speed to objects having a wide of, for example, 1500 mm in order to increase productivity. In addition, a head group including 100 to 200 spray heads arranged in one or more rows orthogonal to the direction of movement of an object with a width of, for example, 1500 mm can spray with impact in order to increase the productivity. If necessary, the head group can be moved back and forth (swung) in the head arrangement direction by, for example, 15 mm to sufficiently lap a pattern of, for example, 15 mm. The heads can be arranged for the required type of the slurry and for the desired number of laminations to meet the required speed.

When the structure of the head wants to be simplified, grooves, for example, every 10 millimeters in the width direction (disclosed in JPH08-309269A, of which inventor is the same as the present inventor) are formed by using a wide roll capable of forming grooves, for example, every 10 millimeters in the width direction (disclosed in JPH08-309269A, of which inventor is the same as the present inventor) and the slurry filled in the grooves is converted into particles by compressed gas, which can be adhered to the object. The speed of the object can theoretically be 100 meters per minute or more. Preferably, the number of roll devices to be placed orthogonal to the direction of movement of the object is determined according to the type of the slurry and the number of laminations.

In addition, a plurality of rotary screens can be installed in the direction of movement, based on the invention of the present inventor in JPH06-86956. A cylindrical screen or seamless belt with a width equal to or wider than the width of the object to be coated, equipped with numerous through holes (e.g., 150 micrometer diameter holes) filled with the slurry or powder, may be used. When this cylindrical screen or seamless belt faces the object, the slurry is converted into fine particles to spray them by liquefied or compressed gas and evenly adhere to the entire surface of the object. Instead, a commercially available rotary screen for screen printing can be used to reduce the cost. The same effect can also be obtained by using a cylindrical pipe wider than the object, for example, with staggered holes of about 0.3 mm or 0.5 mm in diameter with a pitch of 1.5 mm.

For the above two methods, the distance between the object and the location where the particles are blown out should be 1 to 60 millimeters to improve the impact effect. In the above two methods which also double as a volumetric feeding method, the line can be followed by changing the rotation speed, so there is no need for expensive pumps or controllers, and in the roll-to-roll process of a roll coater or rotary screen printer, equipment design and manufacturing can be performed and it is also possible to modify and use the electrode lines of some conventional lithium batteries.

In this invention, the slurry can be made into particles and moved by pressure difference, and the particleization can be performed by inkjet. It can also be particleized by a disc or bell rotating atomizer used in the general coating field. Other methods such as atomization with a bubbler or ultrasonic waves and further refinement by hitting a rotating roll at close range with a spray stream are also acceptable. A particle group converted into particles may be transferred by carrier gas and attached to the object by differential pressure.

The impact of the differential pressure can be increased by using a higher gas pressure just before attachment to draw out the particles with an ejector effect and make them collide at high speed.

Furthermore, if the movement is performed in pulses, the adhesion efficiency and impact will be increased, which is even better.

### INDUSTRIAL APPLICABILITY

According to this embodiment, an all-solid-state battery with low interfacial resistance and high adhesiveness, which has a laminated structure including electrolyte, electrodes, and current collectors, can be manufactured with high quality.

### DESCRIPTION OF THE REFERENCE NUMERAL

1 Positive electrode current collector
2, 4 Active material splay particles
2′ Electrode active material
3, 5 Electrolyte splay particles
3′ Electrolyte particles
6 Solvent splay particles or the like
7 Electrode active material splay particle group
8 Electrolyte spray particle group
9, 9′ Conductive assistant
10 Negative electrode current collector
11 Positive layer
12 Electrolyte layer
13 Negative layer
21, 22, 23, 24, 25, 27, 111, 112 Spray head (coating device)
31, 31′ Roll
101 Stacked material
110 Unwinding device (belt) of an object
120 Substrate (belt)
130 Object
140 Composite
150 Connecting pipe
160 Winding device
170 Free roll
201 Coating chamber
202 Vacuum chamber
203 Pre-vacuum chamber
300, 301, 302 Vacuum pump

1. A method for manufacturing an all-solid-state battery having a positive electrode, an electrolyte, and a negative electrode in layers, comprising:
selecting at least two materials selected from the group consisting of positive electrode active material particles, electrolyte particles or short fibers, negative electrode active material particles or short fibers, conductive assistant particles or short fibers, and a binder; and
by using each coating device for the respective materials, applying the materials alternately on an object so as to form multiple thin layers,
wherein the object is at least one selected from the group consisting of a positive electrode current collector, a positive electrode layer, an electrolyte layer, a negative electrode layer, and a negative electrode current collector.

2. The method according to claim 1, wherein the number of the layers made of the particles or the fibers is 2 to 30.

3. The method according to claim 1, wherein the at least two materials are positive electrode active material particles and electrolyte particles or short fibers.

4. The method according to claim 1, wherein
the at least two materials are at least three materials,
the conductive assistant is selected from at least one of carbon nanofibers, porous carbon particles, carbon nanotubes, and graphene,
the conductive assistant and the active material are alternately applied, and
the conductive assistant is at least scattered thereby the conductive assistant do not form a continuous layer.

5. The method according to claim 1, wherein the electrolyte is sulfide, and
the positive electrode active material is porous carbon particles or carbon short fibers and metallic silicon or silicon oxide (SiOx).

6. The method according to claim 1, wherein the object is an oxide electrolyte, and
the positive active material and the conductive assistant are alternately applied.

7. The method according to claim 6, wherein a base of the oxide electrolyte is lithium lanthanum zirconia,
the positive electrode active material is sulfur particles, and
the conductive assistant is at least one selected from the group consisting of carbon nanofibers, mesoporous carbon particles, carbon nanotubes, and graphene.

8. The method according to claim 1, wherein at least two slurries comprising a solvent and at least one selected from the positive electrode active material particles, electrolyte particles or short fibers, negative electrode active material particles or short fibers, conductive assistant particles or short fibers, and binder are alternately applied on the object to form the multiple thin layers.

9. The method according to claim 8, wherein each slurry is applied to the object in the form of particles in order to form fine irregularities at least at an interface between the positive electrode layer and the electrolyte layer, or at an interface between the electrolyte layer and the negative electrode layer of the positive electrode active material particles, electrolyte particles or short fibers, negative electrode active material particles or short fibers, conductive assistant particles or short fibers, and binder to increase a surface area of each interface.

10. The method according to claim 9, wherein the slurry is applied as particles with a pulsed dosing device or a pulsed splay coating device head,
pulses are applied at 1 to 1000 Hz, and
a distance between the head and the object is 1 to 60 mm.

11. The method according to claim 9, wherein the fine irregularities promote volatilization of the solvent of the slurry particles by heating the object, and
the fine irregularities include a combination of irregularities of trajectory caused by lapping of pulsed spray pattern and fine irregularities caused by the spray particles.

12. The method according to claim 1, further comprising filling or applying alternately the at least two materials selected from the group consisting of positive electrode active material particles, electrolyte particles or short fibers, negative electrode active material particles or short fibers, conductive assistant particles or short fibers, and binder on at least one substrate in advance so as to form the multiple thin layers, and
transporting the filled or applied materials with a pressure difference to the upstream of the object under vacuum to apply and deposit the materials onto the object by splaying.

13. The method according to claim 12, wherein the filling or applying of the at least two materials onto the at least one substrate in the form of the multiple thin layers is filling or applying onto separate substrates, and
the materials on the separate substrates are transported to the upstream of the object with a pressure difference under vacuum to apply and deposit the material alternately onto the object by splaying.

14. The method according to claim 12, wherein the filling or applying of the at least two materials onto the at least one substrate in the form of the multiple thin layers is to apply the at least two slurries comprising a solvent and at least one selected selected from the positive electrode active material particles, electrolyte particles or short fibers, negative electrode active material particles or short fibers, conductive assistant particles or short fibers, and binder.
